(19) United States
(12) Patent Application Publication
(10) Pub. No.: US 2008/0114685 A1
(43) Pub. Date: May 15, 2008

(54) System and method for preventing unauthorized installation of a software program

(76) Inventors: Keen Hun Leong, Bayan Lepas (MY); Siew Yee Lai, Ipoh (MY)

Correspondence Address: Kathy Manke;Avago Technologies Limited, 4380 Ziegler Road, Fort Collins, CO, 80525, US

(21) Appl. No.: 11/599,736

(22) Filed: Nov. 15, 2006

(51) Int. Cl. G06Q 99/00

(52) U.S. Cl. 705/51

(57) ABSTRACT

A system and method for preventing unauthorized installation of a software program utilizes an activation key that is based on a hardware key and a software key. The hardware key is associated with a particular hardware device, while the software key is associated with the software program to be installed. Installation of the software program in a hardware device is enabled to proceed only if the software key extracted from the activation key matches the software key of the software program.

### BACKGROUND OF THE INVENTION

Unauthorized use of software programs is a great concern of software developers. Some estimate that over forty percent of software programs currently being used are unauthorized. However, effective means to prevent unauthorized use of software programs without a significant burden on the legitimate users has been elusive.

Currently, a software program is usually encoded with an activation key, which must be provided during installation to enable the installation process. The activation key is usually printed on the accompanying documentation of the computer product containing the software program. Thus, the software program cannot be installed unless the corresponding activation key is provided, which may deter wide distribution of that software program to unauthorized users.

However, if copies of both the software program and the activation key are distributed, the software program can be installed in any unauthorized computer systems using the same installation process that can be performed by the legitimate user of the software program. Thus, the use of an activation key cannot prevent wide distribution of software programs to unauthorized users.

Furthermore, the activation key does not prevent the original purchaser of the software program from returning the software program for a refund and then continuing to use the returned software program. The original purchaser may continue to use the returned software program by simply not uninstalling the software program from his/her computer system. Alternatively, the original purchaser may continue to use the returned software program by simply reinstalling the software program using copies of the software program and the activation key.

Thus, there is a need for a system and method for preventing unauthorized installation of a software program that addresses the above-described concerns.

### SUMMARY OF THE INVENTION

A system and method for preventing unauthorized installation of a software program utilizes an activation key that is based on a hardware key and a software key. The hardware key is associated with a particular hardware device, while the software key is associated with the software program to be installed. Installation of the software program in a hardware device is enabled to proceed only if the software key extracted from the activation key matches the software key of the software program.

A system for preventing unauthorized installation of a software program in accordance with an embodiment of the invention comprises an activation server and a hardware device. The activation server is configured to generate an activation key based on a hardware key and a software key. The hardware key is associated with a particular hardware device. The software key is associated with the software program. The hardware device is configured to process the activation key during an installation process of the software program to extract at least the software key from the activation key. The hardware device is further configured to compare the software key extracted from the activation key with a corresponding software key of the software program. The hardware device is further configured to enable the installation process of the software program to proceed only if the software key matches the corresponding software key.

A method for preventing unauthorized installation of a software program in accordance with an embodiment of the invention comprises initiating an installation process of the software program at a hardware device using an activation key based on a hardware key and a software key, the hardware key being associated with a particular hardware device, the software key being associated with the software program, processing the activation key to extract at least the software key from the activation key at the hardware device, comparing the software key extracted from the activation key with a corresponding software key of the software program at the hardware device, and enabling the installation process of the software program in the hardware device to proceed only if the software key matches the corresponding software key.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of a system for preventing unauthorized installation of software programs in accordance with an embodiment of the invention.

FIG. 2 is a block diagram of an activation server included in the system of FIG. 1 in accordance with an embodiment of the invention.

FIG. 3 is a block diagram of a hardware device included in the system of FIG. 1 in accordance with an embodiment of the invention.

FIG. 4 is a process flow diagram of the operation of the system of FIG. 1 to prevent unauthorized installation of a purchased software program in accordance with an embodiment of the invention.

FIG. 5 is a process flow diagram of the operation of the system of FIG. 1 to prevent unauthorized installation of a purchased software program in accordance with an alternative embodiment of the invention.

FIG. 6 is a flow diagram of the process of generating an uninstallation key and verifying the uninstallation key for a refund in accordance with an embodiment of the invention.

FIG. 7 is a flow diagram of the process of validating an activation key during installation of a software program to prevent unauthorized installation of a returned software program in accordance with an embodiment of the invention.

FIG. 8 is a process flow diagram of a method of preventing unauthorized installation of a software program in accordance with an embodiment of the invention.

### DETAILED DESCRIPTION

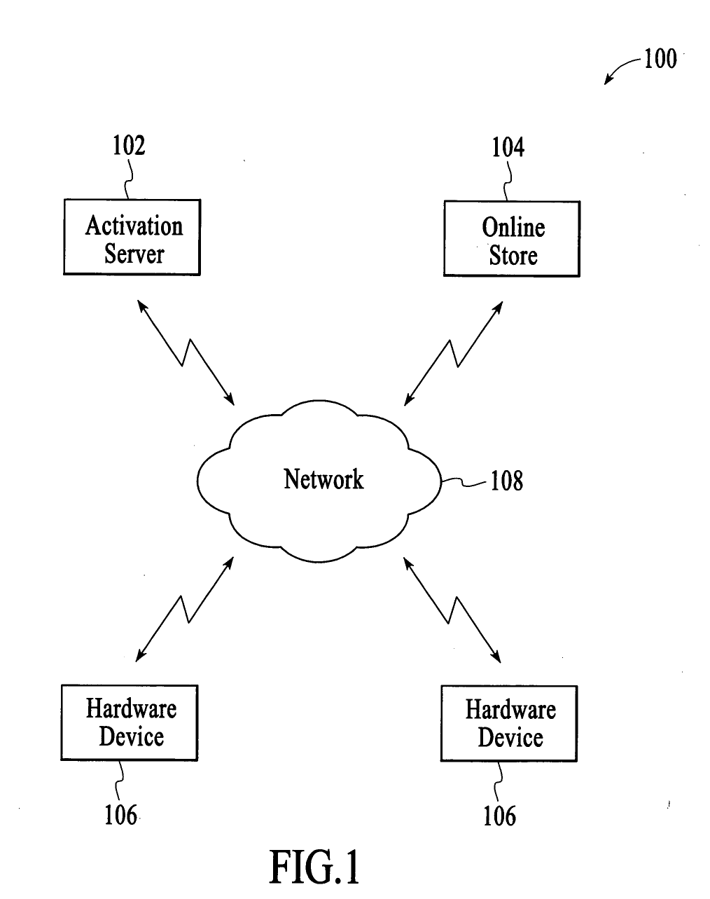

With reference to FIG. 1, a system 100 for preventing unauthorized installation of software programs in accordance with an embodiment of the invention is described. The system 100 prevents unauthorized installation of software programs by requiring a valid activation key, which is specific to a particular hardware device. Thus, the system 100 only allows a software program to be installed in the designated hardware device with a valid activation key. Consequently, the system 100 prevents software programs being installed in unauthorized hardware devices, as well as being reinstalled in a previously installed hardware device after the software program has been returned for a refund.

As shown in FIG. 1, the system 100 includes an activation server 102, an online store 104 and a number of customer hardware devices 106, which are connected to a network 108. The network 108 can be any network that allows data to be transmitted between the activation server 102, the online store 104 and the customer hardware devices 106. As an example, the network 108 may be a large area network (LAN) or the Internet.

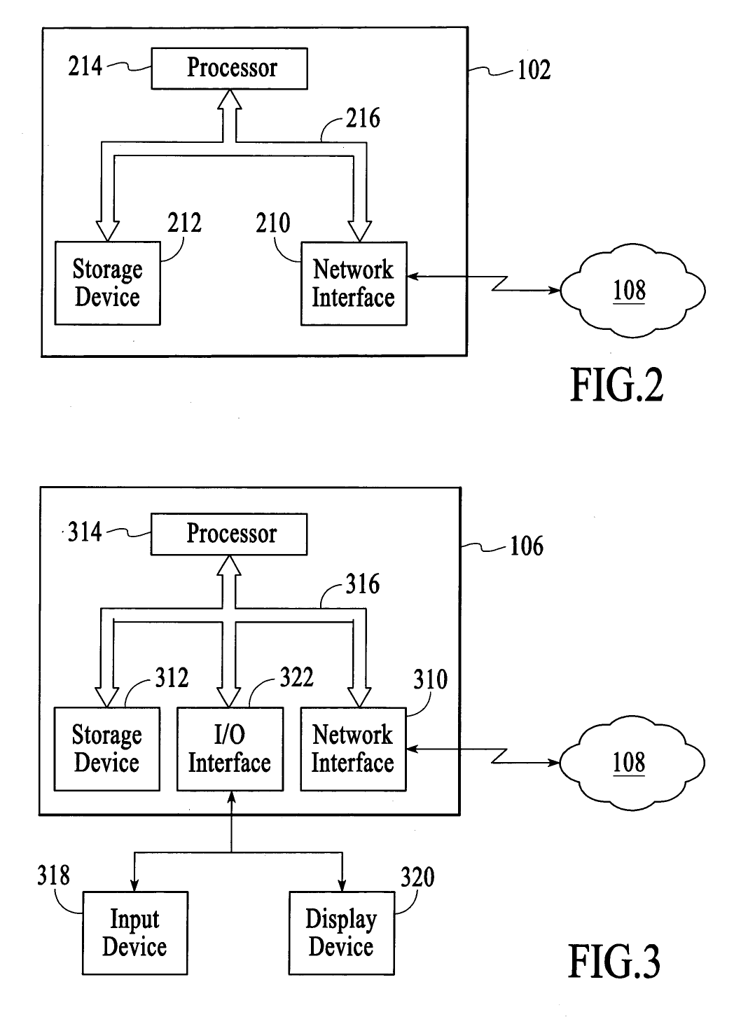

The activation server 102 of the system 100 is a server associated with the proprietor of one or more software programs, which are being prevented from unauthorized installation. As shown in FIG. 2, the activation server 102 includes a network interface 210, a storage device 212 and a processor 214, which are connected to a bus 216. The network interface 210 is configured to allow the activation server 102 to communicate with the online store 104 and the customer hardware devices 106 through the network 108. As an example, the network interface 210 may be a network card or adapter. The storage device 212 may be a hard drive, which is commonly found in a personal computer. In other embodiments, the storage device 212 may be any type of computer memory, such as a FLASH memory or a read-only memory (ROM). The storage device 212 is used to store data and computer programs needed by the activation server 102. In particular, the storage device 212 includes an encryption algorithm, which can generate an encrypted activation key based on a software key, a hardware key and a purchase key.

The software key is a string of code that is uniquely assigned to a particular type of software programs. That is, the same software programs will have the same software key. Thus, different types of software programs will have different software keys. The hardware key is an identification code that is unique to each customer hardware device. As an example, the hardware key may be a string of unique code that is hard-coded into a processor of a customer hardware device. As another example, the hardware key may be the MAC address of a customer hardware device. The purchase key is a string of code that is unique to the time of purchase of a particular software program. As an example, the purchase key may be the time and date of the purchase transaction. As another example, the purchase key may be a particular number of a running number at the time of purchase.

The processor 214 of the activation sever 102 is a digital signal processor that processes data to perform various functions. In particular, the processor 214 is configured or programmed to execute the encryption algorithm stored in the storage device 212 to produce an activation key for each purchased software program. In this embodiment, the processor 214 is configured to encrypt the software key, the hardware key and the purchase key using a private encryption/decryption key to generate the activation key for each purchased software program. The processor 214 can then transmit the activation key directly or via the online store 104 to the hardware device 106 being used to purchase the software program.

The online store 104 of the system 100 is a website for selling one or more software programs. The online store 104 may be located at any server connected to the network 108, including the activation server 102. The online store 104 is configured or programmed to request and receive the hardware key from each purchaser of a software program. The online store 104 is also configured or programmed to generate the purchase key when a software program is being purchased, e.g., at the exact time of the purchase transaction. The online store 104 is further configured to extract the software key for the purchased software program. When a software program has been purchased, the online store 104 transmits the software key, the hardware key and the purchase key to the activation server 102 so that the activation server can generate an activation key based on the transmitted software, hardware and purchase keys.

The customer hardware devices 106 of the system 100 are devices that can communicate with the online store 104 and/or the activation server 102 to transmit and receive data. Thus, the customer hardware devices 106 can be used to purchase software programs from the online store 104 and receive activation keys, which are generated by the activation server 102, directly from the activation sever or indirectly from the activation server via the online store. In this embodiment, the customer hardware devices 106 are assumed to be the devices in which the purchased software programs are to be installed. However, in other embodiments, the software programs may be purchased to be installed in other hardware devices similar to the hardware devices 106, which may or may not be connected to the network 108.

Turning now to FIG. 3, one of the customer hardware devices 106 in accordance with an embodiment of the invention is shown. As shown in FIG. 3, the customer hardware device 106 includes a network interface 310, a storage device 312 and a processor 314, which are connected to a bus 316. The network interface 310 is configured to allow the customer hardware device 106 to communicate with the online store 104 and/or the activation server 102 through the network 108. As an example, the network interface 310 may be a network card or adapter with a unique Media Access Control (MAC) address stored in an internal ROM (not shown). The storage device 312 may be a hard drive, which is commonly found in a personal computer. In other embodiments, the storage device 312 may be any type of computer memory, such as a FLASH memory or a ROM. The storage device 312 is used to store data and computer programs needed by the hardware device 106. In particular, the storage device 312 includes a decryption algorithm, which can decrypt an encrypted activation key from the activation sever 102 using a private encryption/decryption key, which is the same private key used by the activation server to generate the activation key.

The processor 314 of the customer hardware device 106 is a digital signal processor that processes data to perform various functions. In particular, the processor 314 is configured or programmed to execute the decryption algorithm stored in the storage device 312 on an activation key from the activation sever 102 to extract the software key, the hardware key and the purchase key from the activation key. The decryption algorithm is executed during installation of a purchased software program. The processor 314 is also configured to compare the extracted hardware key with the hardware key of this customer hardware device 106, and to compare the extracted software key with the software key of the software program being installed. The installation of the software program is enabled to proceed only if these two extracted keys match the respective keys.

As shown in FIG. 3, the customer hardware device 106 may also include an input device 318 and a display device 320, which are connected to an input/output (I/O) interface 322. The input device 318 may be a keyboard or another type of an input device. The display device 320 may be a computer monitor, such as a liquid crystal display (LCD). The I/O interface 322 is connected to the bus 316 to allow transmission of signals between the processor 314 and both the input device 318 and the display device 320.

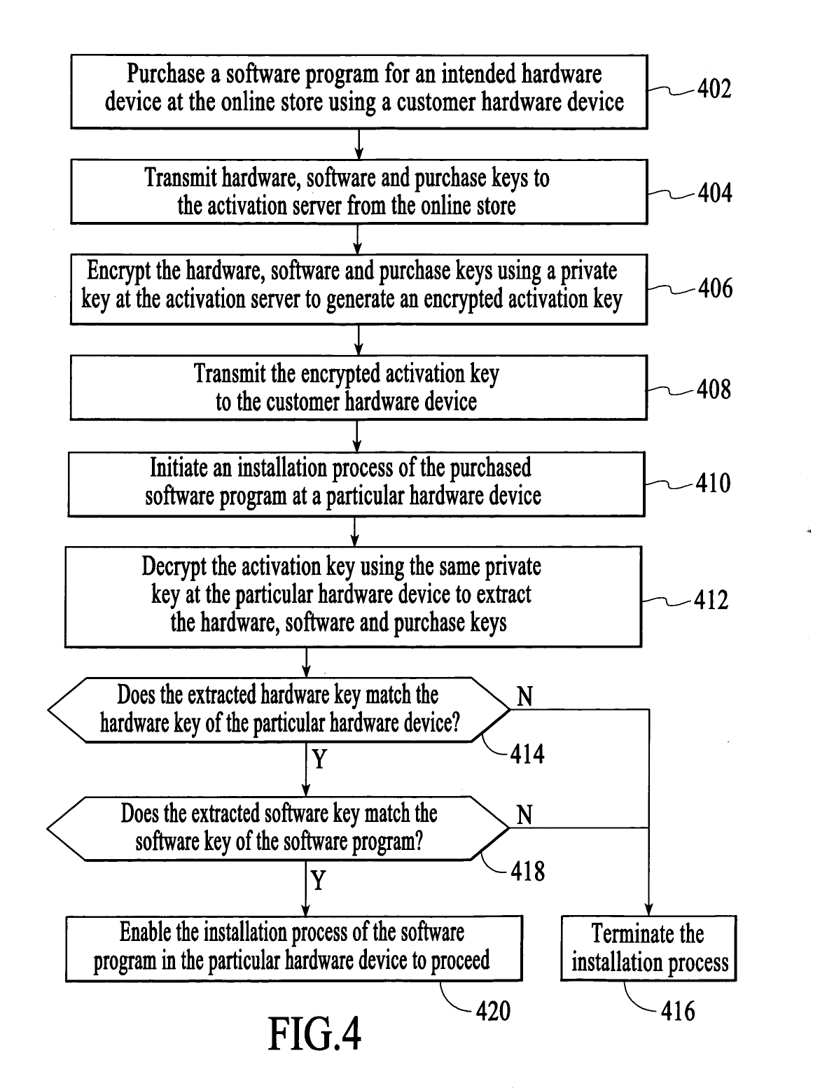

The operation of the system 100 to prevent unauthorized installation of a purchased software program in accordance with an embodiment of the invention is described with reference to a process flow diagram of FIG. 4. At block 402, a software program for an intended hardware device is purchased at the online store 104 using one of the customer hardware devices 106. Next, at block 404, the hardware key of the intended hardware device, the software key of the purchased software program and the purchase key of the purchase transaction are transmitted to the activation server 102 from the online store 104. Next, at block 406, the activation server 102 encrypts the hardware, software and purchase keys using a private key to generate an encrypted activation key for the purchased software program. Next, at block 408, the encrypted activation key is transmitted to the customer hardware device 106 being used for the purchase of the software program either directly or through the online store 104.

Next, at block 410, an installation process of the purchased software program is initiated at a particular hardware device using the encrypted activation key. Next, at block 412, the processor of the particular hardware device decrypts the activation key using the same private encryption/decryption key that was used for encryption by the activation server 102 to extract the hardware, software and purchase keys from the activation key.

Next, at block 414, a determination is made by the processor of the particular hardware device whether the extracted hardware key matches the hardware key of the particular hardware device. If the keys do not match, then the operation proceeds to block 416, where the installation process of the purchased software program is terminated. Thus, the purchased software program is not installed in the particular hardware device. However, if the keys do match, then the operation proceeds to block 418.

At block 418, a determination is made by the processor of the particular hardware device whether the extracted software key matches the software key of the software program being installed. If the keys do not match, then the operation proceeds to block 416, where the installation process of the purchased software program is terminated. However, if the keys do match, then the operation proceeds to block 420, where the installation process of the purchased software program in the particular hardware device is enabled to proceed so that the purchased software program can be properly installed.

In an alternative embodiment, the system 100 uses an encrypted activation key that includes only the software and purchase keys. In this alternative embodiment, the hardware key is not encrypted into the activation key. Rather, the hardware key is used as a private encryption/decryption key to encrypt and decrypt the activation key. Thus, in this embodiment, the activation server 102 is configured to encrypt the software and purchase keys using the hardware key as an encryption key to generate an encrypted activation key for the purchased software program. Accordingly, the hardware devices 106 are configured to decrypt the encrypted activation key using the hardware key as a decryption key to extract the software and purchase keys. The extracted software key is then compared with the software key of the software program being installed to determine whether the installation of the software program in the current hardware device is authorized.

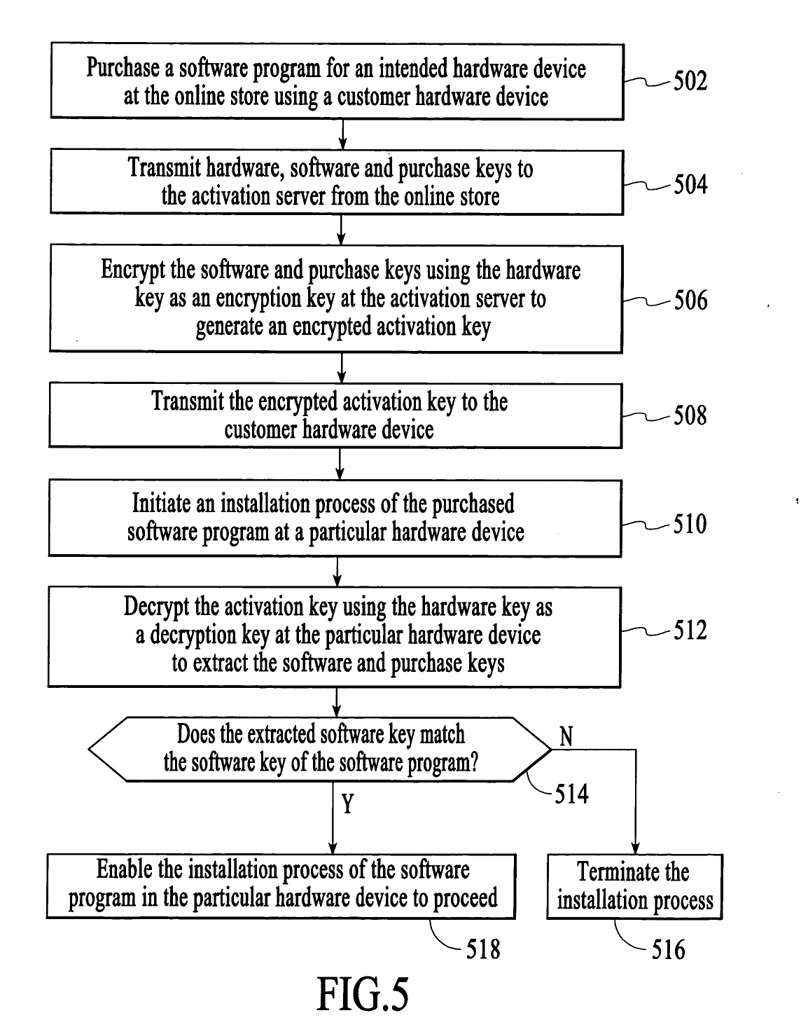

The operation of the system 100 to prevent unauthorized installation of a purchased software program in accordance with the alternative embodiment of the invention is described with reference to a process flow diagram of FIG. 5. At block 502, a software program for an intended hardware device is purchased at the online store 104 using one of the customer hardware devices 106. Next, at block 504, the hardware key of the intended hardware device, the software key of the purchased software program and the purchase key for the purchase transaction are transmitted to the activation server 102 from the online store 104. Next, at block 506, the activation server 102 encrypts the software and purchase keys using the hardware key as an encryption key to generate an encrypted activation key for the purchased software program. Next, at block 508, the encrypted activation key is transmitted to the customer hardware device 106 being used for the purchase of the software program either directly or through the online store 104.

Next, at block 510, an installation process of the purchased software program is initiated at a particular hardware device using the encrypted activation key. Next, at block 512, the processor of the particular hardware device decrypts the encrypted activation key using the hardware key as a decryption key to extract the software and purchase keys from the activation key.

Next, at block 514, a determination is made by the processor of the particular hardware device whether the extracted software key matches the software key of the purchased software program. If the keys do not match, then the operation proceeds to block 516, where the installation process of the purchased software program is terminated. However, if the keys do match, then the operation proceeds to block 518, where the installation process of the purchased software program in the particular hardware device is enabled to proceed so that the purchased software program can be properly installed.

In another embodiment, the system 100 may be configured to prevent unauthorized installation of a returned software program in a hardware device. In this embodiment, the activation server 102 provides a refund authorization for a returned software program to the online store 104 only after the activation server receives a valid uninstallation key from the hardware device 106 in which the software program was previously installed. Accordingly, in this embodiment, each hardware device 106 is configured to encrypt the original activation key of a purchased software program to produce an uninstallation key when the purchased software program is being uninstalled for a refund. In this embodiment, the original activation key is stored in the register of the processor of the hardware device 106 (or the storage device of the hardware device) when the software program was originally being installed in the hardware device. If the software program is being uninstalled for any purpose other than for a refund, then the hardware device does not produce the uninstallation key. When an uninstallation key is generated, the corresponding activation key in the register of the processor is flagged or indicated as being invalid in the register. Consequently, the returned software program cannot be reinstalled in the hardware device using the original activation key since that activation key has been flagged as being invalid.

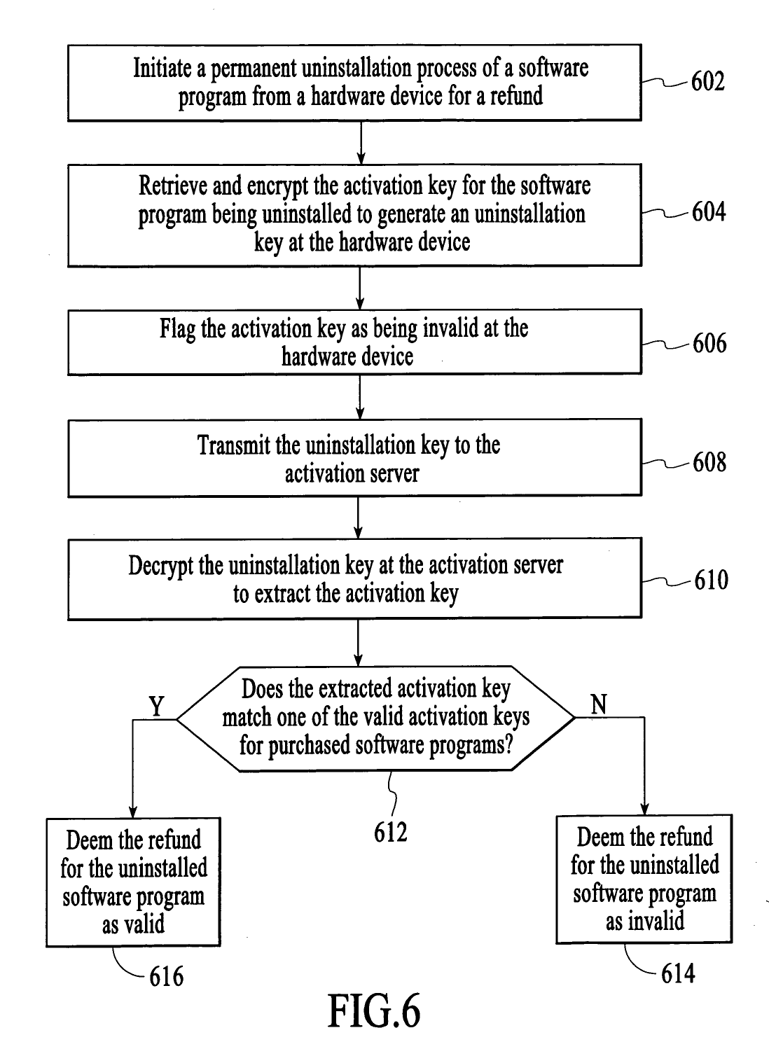

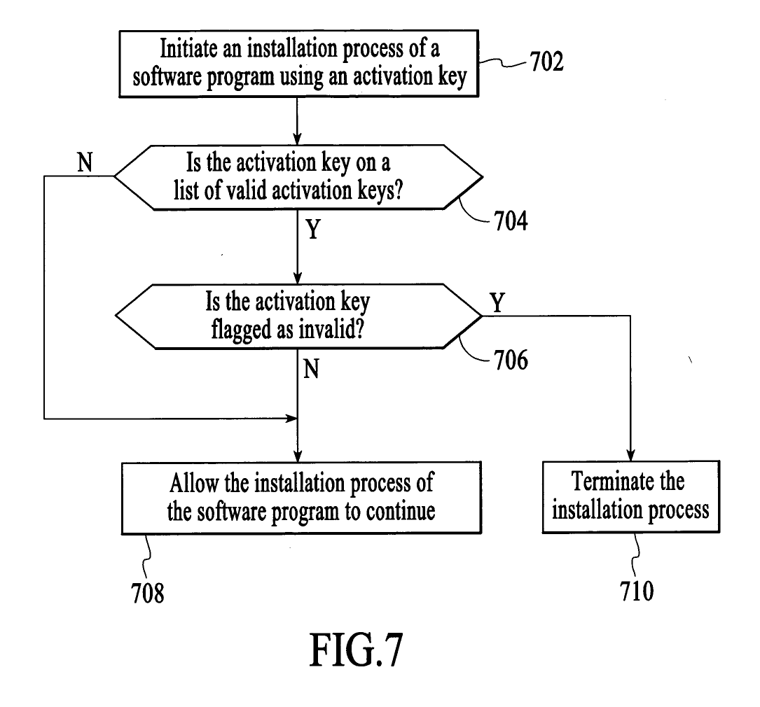

The operation of the system 100 to prevent unauthorized installation of a returned software program in accordance with an embodiment of the invention is described with reference to process flow diagrams of FIGS. 6 and 7. The flow diagram of FIG. 6 illustrates the process of generating an uninstallation key and verifying the uninstallation key for a refund in accordance with an embodiment of the invention. The flow diagram of FIG. 7 illustrates the process of validating an activation key during installation of a software program to prevent unauthorized installation of a returned software program in accordance with an embodiment of the invention.

The process of generating an uninstallation key and verifying the uninstallation key for a refund in accordance with an embodiment of the invention begins at block 602, where a user initiates a permanent uninstallation process of a software program from a hardware device for a refund. Next, at block 604, the processor of the hardware device retrieves and encrypts the activation key for the software program being uninstalled to generate an uninstallation key. Next, at block 606, the processor of the hardware device flags the activation key in the register or the storage device of the hardware device as being invalid. Next, at block 608, the uninstallation key is transmitted to the activation server 102 through the network 108.

Next, at block 610, the activation server 102 decrypts the uninstallation key to extract the activation key. Next, at block 612, a determination is made by the processor of activation server whether the extracted activation key matches one of the valid activation keys for purchased software programs. If the keys do not match, then the process proceeds to block 614, where the refund for the uninstalled software program is deemed invalid. If the keys do match, then the process proceeds to block 616, where the refund for the uninstalled software program is deemed valid. Depending on whether a refund is authorized, i.e., deemed valid or invalid, the online store 104 make a refund for the uninstalled software program and notifies the user of the refund or simply notifies the user that a refund is not authorized for the uninstalled software program.

The process of validating an activation key during the installation of a software program to prevent unauthorized installation of a returned software program in accordance with an embodiment of the invention begins at block 702, where a user initiates an installation process of the software program in a hardware device using an activation key. Next, at block 704, a determination is made by the processor of the hardware device whether the activation key is on a list of activation keys in the register or the storage device of the hardware device. If no, then the process proceeds to block 708, where the installation process is allowed to continue. However, if the activation key is on the list, then the process proceeds to block 706.

At block 706, a determination is made by the processor of the hardware device whether the activation key in the list of activation keys is flagged as invalid. If yes, then the process proceeds to block 710, where the installation process is terminated. However, if the activation key is not flagged as invalid, then the process proceeds to block 708, where the installation process of the software program in the hardware device is allowed to proceed, which may include performing one of the operations described above with respect to FIGS. 4 and 5.

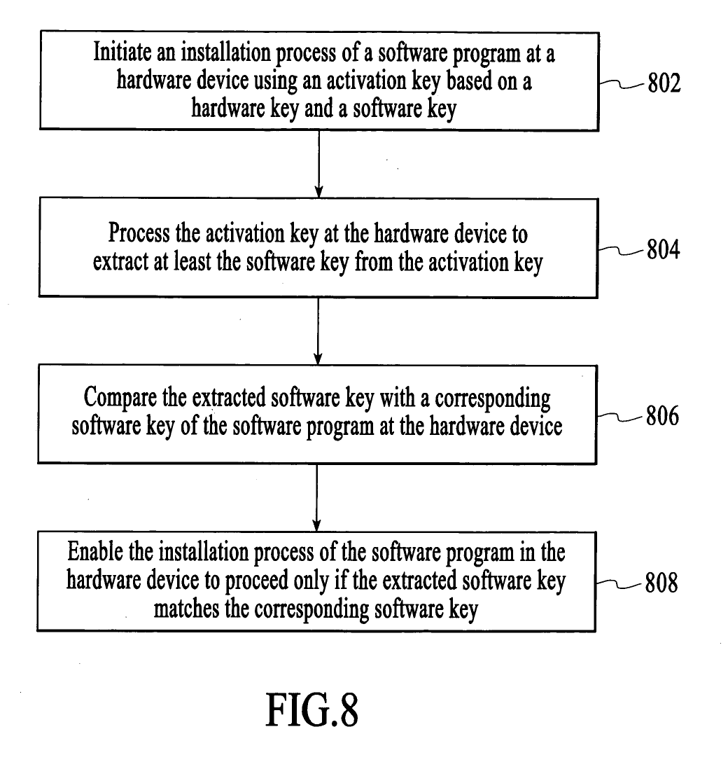

A method for preventing unauthorized installation of a software program in accordance with an embodiment of the invention is described with reference to a process flow diagram of FIG. 8. At block 802, an installation process of the software program is initiated at a hardware device using an activation key based on a hardware key and a software key. The hardware key is associated with a particular hardware device. The software key is associated with the software program. Next, at block 804, the activation key is processed at the hardware device to extract at least the software key from the activation key. Next, at block 806, the extracted software key is compared with a corresponding software key of the software program at the hardware device. Next at block 808, the installation process of the software program in the hardware device is enabled to proceed only if the extracted software key matches the corresponding software key.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for preventing unauthorized installation of a software program, said method comprising:
initiating an installation process of said software program at a hardware device using an activation key based on a hardware key and a software key, said hardware key being associated with a particular hardware device, said software key being associated with said software program;
processing said activation key to extract at least said software key from said activation key at said hardware device;
comparing said software key extracted from said activation key with a corresponding software key of said software program at said hardware device; and
enabling said installation process of said software program in said hardware device to proceed only if said software key matches said corresponding software key.

2. The method of claim 1 wherein said processing includes decrypting said activation key to extract said hardware key and said software key from said activation key at said hardware device.

3. The method of claim 2 wherein said decrypting said activation key to extract said hardware key and said software key includes decrypting said activation key to extract said hardware key and said software key from said activation key at said hardware device using a private key.

4. The method of claim 2 further comprising comparing said hardware key extracted from said activation key with a corresponding hardware key of said hardware device, wherein said enabling includes enabling said installation process of said software in said hardware device to proceed only if said software key matches said corresponding software key and said hardware key matches said corresponding hardware key.

5. The method of claim 2 further comprising encrypting said hardware key and said software key to generate said activation key.

6. The method of claim 1 wherein said processing includes decrypting said activation key to extract at least said software key from said activation key at said hardware device using said hardware key as a decryption key.

7. The method of claim 6 further comprising encrypting said software key using said hardware key as an encryption key to generate said activation key.

8. The method of claim 1 wherein said decrypting includes decrypting said activation key to extract at least said software key and a purchase key, said purchase key being associated with a purchase transaction of said software program.

9. The method of claim 1 further comprising:
initiating an uninstallation process of said software program from said hardware device;
generating an uninstallation key using said activation key, said uninstallation key being used for a refund for said software program; and
flagging said activation key at said hardware device as being invalid.

10. The method of claim 9 further comprising:
initiating another installation process of said software program in said hardware device using said activation key;
determining whether said activation key has been flagged as being invalid; and
enabling said another installation process of said software program in said hardware device to proceed only if said activation key has not been flagged as being invalid.

11. A system for preventing unauthorized installation of a software program comprising:
an activation server configured to generate an activation key based on a hardware key and a software key, said hardware key being associated with a particular hardware device, said software key being associated with said software program; and
a hardware device configured to process said activation key during an installation process of said software program to extract at least said software key from said activation key, said hardware device being further configured to compare said software key extracted from said activation key with a corresponding software key of said software program, said hardware device being further configured to enable said installation process of said software program to proceed only if said software key matches said corresponding software key.

12. The system of claim 11 wherein said hardware device is configured to decrypt said activation key to extract said hardware key and said software key from said activation key.

13. The system of claim 12 wherein said hardware device is configured to decrypt said activation key to extract said hardware key and said software key from said activation key using a private key.

14. The system of claim 13 wherein said activation server is configured to encrypt said hardware key and said software key using said private key to generate said activation key.

15. The system of claim 12 wherein said hardware device is configured to compare said hardware key extracted from said activation key with a corresponding hardware key of said hardware device, said hardware device being further configured to enable said installation process of said software in said hardware device to proceed only if said software key matches said corresponding software key and said hardware key matches said corresponding hardware key.

16. The system of claim 11 wherein said hardware device is configured to decrypt said activation key to extract at least said software key from said activation key at said hardware device using said hardware key as a decryption key.

17. The system of claim 16 wherein said activation server is configured to encrypt said software key using said hardware key as an encryption key to generate said activation key.

18. The system of claim 11 wherein said activation server is configured to encrypt at least said software key and a purchase key to generate said activation key, said purchase key being associated with a purchase transaction of said software program.

19. The system of claim 11 wherein said hardware device is configured to generate an uninstallation key using said activation key during an uninstallation process of said software program from said hardware device, said uninstallation key being used for a refund for said software program, said hardware device being further configured to flag said activation key in said hardware device as being invalid.

20. The system of claim 19 wherein said hardware device is configured to determine whether said activation key has been flagged as being invalid during another installation process of said software program in said hardware device using said activation key, said hardware device being configured to enable said another installation process of said software program in said hardware device to proceed only if said activation key has not been flagged as being invalid.
